(19) United States
(12) Patent Application Publication
(10) Pub. No.: US 2026/0287150 A1
(43) Pub. Date: Sep. 24, 2026

(54) DISPLAY DEVICE AND TRANSPORT MEANS

(71) Applicant: Continental Automotive Technologies GmbH, Hannover (DE)

(72) Inventors: Manrico JOSEPH, Ober-Ramstad (DE); Thomas WENDEL, Fischbachtal (DE)

(21) Appl. No.: 19/475,589

(22) PCT Filed: Apr. 4, 2024
(86) PCT No.: PCT/DE2024/200016

§ 371 Date: Oct. 15, 2025

(30) Foreign Application Priority Data
Apr. 17, 2023 (DE) 10 2023 203 426.3

(51) Int. Cl. F21V 7/06; B60K 35/22; F21Y 105/16; F21Y 115/10

(52) U.S. Cl. CPC F21V 7/06; B60K 35/22; B60K 2360/23; B60K 2360/332; F21Y 2105/16; F21Y 2115/10

(57) ABSTRACT

A display device and to a transport having a display device of this type. The display device has a curved display panel and a backlight for the display panel. The backlight has at least one flat circuit board with a plurality of light sources and a reflector with a plurality of reflective cavities. At least one of the light sources is arranged in each of the cavities. An underside of the reflector is flat, while an upper side of the reflector is adapted to the curvature of the display panel.

### CROSS REFERENCE TO RELATED APPLICATIONS

This is a U.S. national stage of Application No. PCT/DE 2024/200016 filed Apr. 4, 2024. Priority is claimed on German Patent Application No. DE 10 2023 203 426.3 filed Apr. 17, 2023, the contents of which are incorporated herein by reference.

### BACKGROUND OF THE INVENTION

### 1. Field of the Invention

The present disclosure relates to a display device, in particular a display device having a curved display panel, and to a transport (vehicle) having such a display device.

### 2. Description of the Related Art

The number and area of display devices in a transport are constantly increasing. Display devices can be found in the market for example as an instrument cluster for the driver, as a central display and also as a passenger display. Non-self-illuminating transmissive display devices require backlight for image representation. The task of the backlight is to illuminate the display panel used as uniformly as possible over the entire active surface in order to produce a display that is as homogeneous as possible right down to the edge region.

Matrix backlights use a plurality of light sources arranged in a matrix to produce light. The light from the light sources is directed in the direction of the display panel by means of a reflector.

For example, US 2010/0141867 A1 describes a planar light-emitting device that comprises a reflector with an upper surface, a separating element arranged on the reflector, a plurality of light sources and a diffusing plate. The reflector serves as a light-reflecting surface. The separating element forms a plurality of cavities, in each of which the light sources are arranged. The diffusing plate is held at the upper edges of the separating element. The side surfaces of the separating element that delimit the cavities are light-reflecting surfaces.

Increasingly curved display devices are being used, i.e. display devices the surface of which is not or at least not completely flat but has a curvature. This curvature can be used, for example, to increase the immersion of a viewer or to adapt the shape of the display device to an installation environment, for example in a transport means.

For example, JP 2016-066 085 A describes a display device having a curved display surface. The display device comprises a number of adjacent display modules.

### SUMMARY OF THE INVENTION

A challenge in the case of curved display devices with a matrix backlight consists in the fact that the circuit boards with the light sources arranged in a matrix have to be moved closer to the curved shape of the display device in order to ensure homogeneous illumination at a parallel distance. For this purpose, the circuit boards are bent, which generates tensions which continue into the solder points of the lighting components, such as e.g. the light-emitting diodes and the associated drivers. These tensions have a negative effect on the service life of the connection or of the component.

It is an object of one aspect of the invention to provide an improved display device having a curved display panel and a matrix backlight.

According to a first aspect of the invention, a display device has a curved display panel and a backlight for the display panel, wherein the backlight has:
at least one flat circuit board with a plurality of light sources; and
a reflector with a plurality of reflective cavities in each of which at least one of the light sources is arranged, wherein an underside of the reflector is flat while an upper side of the reflector is adapted to the curvature of the display panel.

According to one aspect of the invention, a reflector is used, that is flat on the underside and follows the upper side of the shape or curvature of the display panel. On the underside, there is at least one flat circuit board with the required light sources. The solution according to one aspect of the invention thus allows the use of flat circuit boards. The use of non-curved circuit boards is cheaper in terms of costs and safer in terms of service life. In addition, handling in production is also easier. The reflector preferably consists of plastic or an elastomer, e.g. of polycarbonate with an admixture of titanium dioxide for the desired reflectivity.

According to one aspect of the invention, the upper side of the reflector follows the curvature of the display panel or approximates the curvature of the display panel. If the upper side is adapted exactly to the curvature of the display panel, a consistently very small distance can be created between the reflector and the display panel. However, an exact adaptation is sometimes more complex to produce. It is easier to achieve an approximation of the shape of the upper side to the curvature of the display panel in that, for example, the walls of the cavities each have a straight upper termination.

According to one aspect of the invention, the upper side of the reflector is convex, concave, in some regions convex and concave or partially flat. The specific refinement of the reflector depends on the shape of the display panel, i.e. on the desired refinement of the display device.

According to one aspect of the invention, a density of the light sources varies over the surface of the at least one flat circuit board. In principle, the light sources can have constant distances, but it is advantageous to use variable distances for homogeneous illumination. In the case of a large distance between the light source and the display panel, the light sources can be closer to one another, for example, in order to increase the luminance.

According to one aspect of the invention, the light sources are controlled or designed in such a way that a light intensity of the light sources varies over the surface of the at least one flat circuit board. As an alternative or in addition to varying the density of the light sources over the surface, it is likewise possible to adjust the light intensity of the light sources over the surface in a controlled manner in order to achieve homogeneous illumination of the display panel. For example, light sources of different maximum illuminating output are arranged at different locations on the circuit board, or light sources of identical maximum illuminating output are controlled differently. A combination of both measures is also possible.

According to one aspect of the invention, the display device has a plurality of flat circuit boards in a spatial arrangement, each with a plurality of light sources. The spatial arrangement of the circuit boards makes it possible to save installation space. In addition, further shapes of the display panel are made possible. A spatial arrangement of the circuit boards is to be understood here to mean that the circuit boards do not all lie in one plane, but rather in different planes. These may be parallel or also inclined to one another.

According to one aspect of the invention, the reflector has a modular construction. In this case, the individual modules preferably each have a circuit board with light sources arranged thereon and a reflector element. The use of modules has the advantage that the reflector is made up of smaller elements that are easier to produce and handle. In particular, the tolerances are less stringent. The production tools required are also smaller, so that the tools can be made faster and the pool of producers who are able to produce them is larger. In addition, there is the possibility of using the modules for differently designed display devices, which is generally not possible in the case of a single-piece reflector. There is preferably a free space between adjacent modules. The free space allows the modules to expand without the adjacent modules colliding with one another and stresses and deformations occurring. For example, a gap with a width of ~0.3 mm can be provided between the modules.

According to one aspect of the invention, walls of the cavities are parabolically or at least partially rounded and the cavities are designed to reflect the light emitted by the light sources in the direction of the display panel. As a result of the parabolic shape or the at least partial rounding, the emitted light can be reflected in a more targeted manner in the direction of the display panel. Preferably, the light sources here are laterally emitting light-emitting diodes, in particular light-emitting diodes, which emit light on all sides. The use of laterally emitting light-emitting diodes has the advantage that the formation of light spots in the backlight is prevented. This ensures that the display panel is illuminated in a particularly homogeneous manner.

A display device according to the invention is preferably used in a transport means. The transport means can be, for example, a motor vehicle, but alternatively also an aircraft, a rail vehicle or a watercraft.

### BRIEF DESCRIPTION OF THE DRAWINGS

Further features of the present invention will become apparent from the following description and the appended claims in connection with the figures.

Overview of the figures

FIG. 1 is a display device with a concave display panel;

FIG. 2 is a display device with a concave display panel;

FIG. 3 is a display device with a concave display panel;

FIG. 4 is a display device with a concave display panel;

FIG. 5 is a display device with a concave display panel;

FIG. 6 is a display device with a convex display panel;

FIG. 7 is a display device with a convex display panel;

FIG. 8 is a display device with a convex display panel;

FIG. 9 is a display device with a convex display panel;

FIG. 10 is a display device with a convex display panel;

FIG. 11 is a display device having a display panel with a regionally convex and concave curvature;

FIG. 12 is a display device having a display panel with a regionally convex and concave curvature;

FIG. 13 is a display having a partially flat display panel; and

FIG. 14 schematically shows a vehicle that uses a display device.

### DETAILED DESCRIPTION OF THE PRESENTLY PREFERRED EMBODIMENTS

For better understanding of the principles of the present invention, embodiments of the invention are explained in more detail below with reference to the figures. The same reference numerals are used in the figures for identical or functionally identical elements and are not necessarily described again for each figure. It is to be understood that the invention is not restricted to the illustrated embodiments and that the features described may also be combined or modified without departing from the scope of protection of the invention as defined in the appended claims.

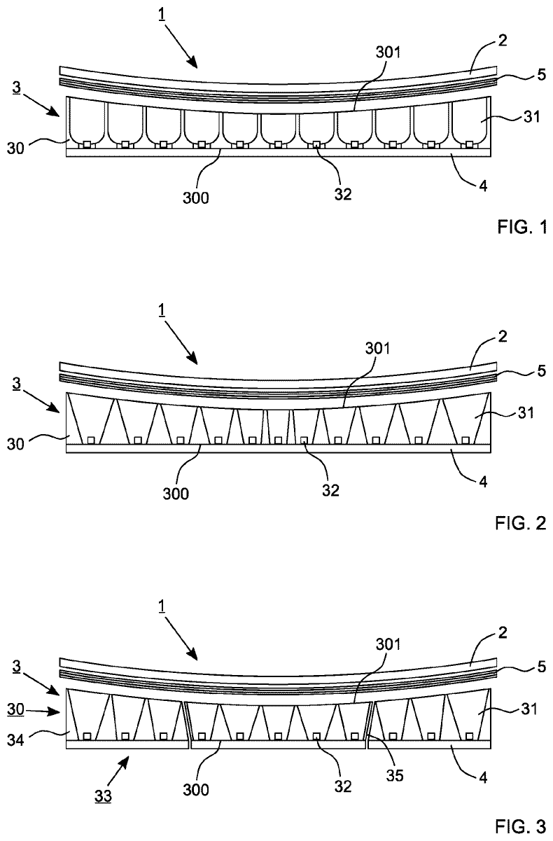

FIG. 1 schematically shows a display device 1 according to one aspect of the invention with a concave display panel 2. A section through the display device 1 is shown. The display device 1 has a backlight 3 for the display panel 2. The backlight 3 has a flat circuit board 4 with a plurality of light sources 32 and a reflector 30 with a plurality of reflective cavities 31. One of the light sources 32 is respectively arranged in each of the cavities 31. An underside 300 of the reflector 30 has a flat design, whereas an upper side 301 of the reflector 30 is adapted to the curvature of the display panel 2. The reflector 30 can preferably consist of plastic or an elastomer, e.g. of polycarbonate with an admixture of titanium dioxide for achieving the desired reflectivity. The cavities 31 are partially rounded in order to reflect the light emitted by the light sources 32 in the direction of the display panel 2. In this embodiment, the light sources 32 are at a constant distance across the surface of the circuit board 4. Between the backlight 3 and the display panel 2 there is, in the illustrated example, an optical foil stack 5. The foils of the optical foil stack 5 have the task of scattering, collecting or directing the light from the reflector 30 in such a way that the requirements in respect of the spatial angles of the backlight 3 are met. Typical foils for light orientation are brightness enhancement films (BEF) and light control films (LCF).

FIG. 2 schematically shows a display device 1 according to one aspect of the invention with a concave display panel 2. A section through the display device 1 is shown. The embodiment largely corresponds to FIG. 1. However, the light sources 32 have a variable distance over the surface of the circuit board 4. In this example, the density of the light sources 32 is greater at the center of the display device 1 than at the edge of the display device 1. For homogeneous illumination of the display panel 2, the light intensity of the light sources 32 can be adjusted in a controlled manner over the surface of the circuit board 4 as required. In addition, the cavities 31 in the illustrated example are not rounded, but have straight, inclined walls.

FIG. 3 schematically shows a display device 1 according to one aspect of the invention with a concave display panel 2. A section through the display device 1 is shown. The display device largely corresponds to the embodiment shown in FIG. 1. However, the reflector 30 has a modular design. In this case, the individual modules 33 each have a circuit board 4 with light sources 32 arranged thereon and a reflector element 34. The use of modules 33 has the advantage that the reflector 30 is made up of smaller elements that are easier to produce and handle. In the example shown, a free space 35 is situated between adjacent modules 33. The free space 35 allows an expansion of the modules 33 without the adjacent modules 33 abutting against one another and stresses and deformations occurring. The cavities 31 in the illustrated example are not rounded, but have straight, inclined walls. The inclination of the walls is chosen such that a main direction of the emitted light runs perpendicular to the display panel 2.

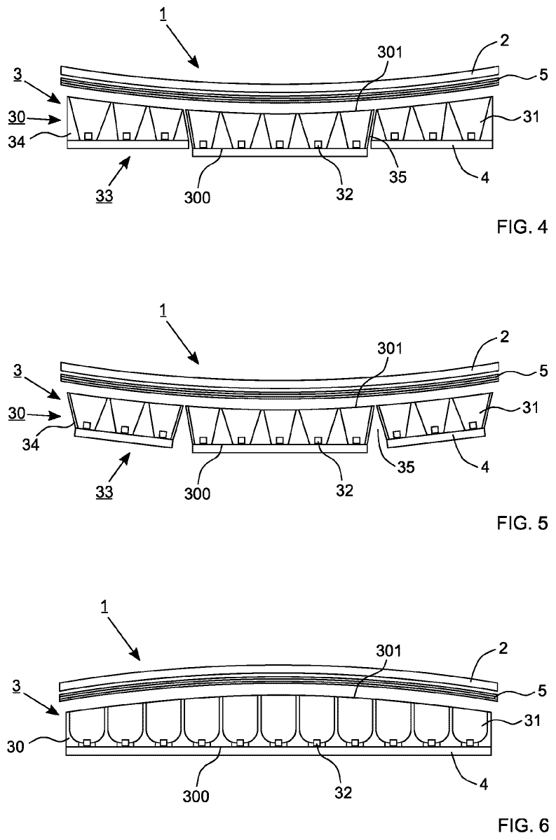

FIG. 4 schematically shows a display device 1 according to one aspect of the invention with a concave display panel 2. A section through the display device 1 is shown. The display device largely corresponds to the display device shown in FIG. 3. The reflector 30 again has a modular design. In this case, the individual modules 33 each have a circuit board 4 with light sources 32 arranged thereon and a reflector element 34. However, the various circuit boards 4 are spatially arranged, that is to say they lie in different planes which are parallel to one another. The spatial arrangement of the various circuit boards 4 saves installation space.

FIG. 5 schematically shows a display device 1 with a concave display panel 2. A section through the display device 1 is shown. The display device largely corresponds to the e display device shown in FIG. 4. The reflector 30 is again of modular construction, but the various circuit boards 4 of the modules 33 lie in mutually inclined planes. This is advantageous in particular in the case of a strong curvature of the display panel.

In FIG. 4 and FIG. 5, the reflector 30 has a modular construction. This is however not mandatory. The reflector 30 can also be designed in one piece. In this case, the underside 300 of the reflector 30 is flat in sections.

FIG. 6 schematically shows a display device 1 with a convex display panel 2. A section through the display device 1 is shown. The display device largely corresponds to the display device shown in FIG. 1, but in this case the display panel 2 is not concave but rather convex. The cavities 31 are partially rounded like in the embodiment of FIG. 1, in order to reflect the light emitted by the light sources 32 in the direction of the display panel 2. In addition, the light sources 32 are at a constant distance across the surface of the circuit board 4.

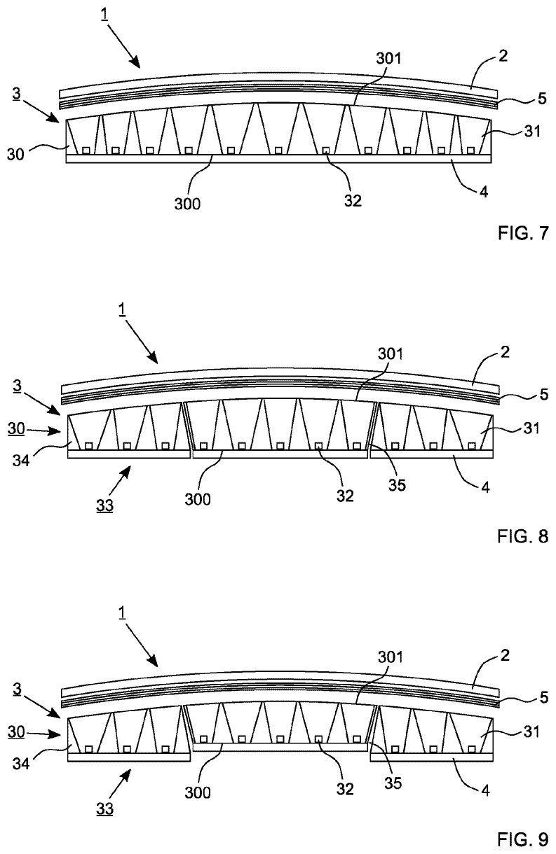

FIG. 7 schematically shows a display device 1 with a convex display panel 2. A section through the display device 1 is shown. The display device largely corresponds to the display device shown in FIG. 6. However, the light sources 32 are at a variable distance over the surface of the circuit board 4. In this example, the density of the light sources 32 is lower at the center of the display device 1 than at the edge of the display device 1. For homogeneous illumination of the display panel 2, the light intensity of the light sources 32 can be adjusted in a controlled manner over the surface of the circuit board 4 as required. In addition, the cavities 31 in the illustrated example are not rounded, but have straight, inclined walls.

FIG. 8 schematically shows a display device 1 with a convex display panel 2. A section through the display device 1 is shown. The display device largely corresponds to the display device shown in FIG. 6. However, the reflector 30 in this display device has a modular design. In this case, the individual modules 33 each have a circuit board 4 with light sources 32 arranged thereon and a reflector element 34. In the example shown, a free space 35 is situated between adjacent modules 33. The free space 35 allows an expansion of the modules 33 without the adjacent modules 33 abutting against one another and stresses and deformations occurring. The cavities 31 in the illustrated example are not rounded, but have straight, inclined walls.

FIG. 9 schematically shows a a display device 1 with a convex display panel 2. A section through the display device 1 is shown. The display device largely corresponds to the display device shown in FIG. 8. The reflector 30 again has a modular design. In this case, the individual modules 33 each have a circuit board 4 with light sources 32 arranged thereon and a reflector element 34. However, the various circuit boards 4 are spatially arranged, that is to say they lie in different planes which are parallel to one another.

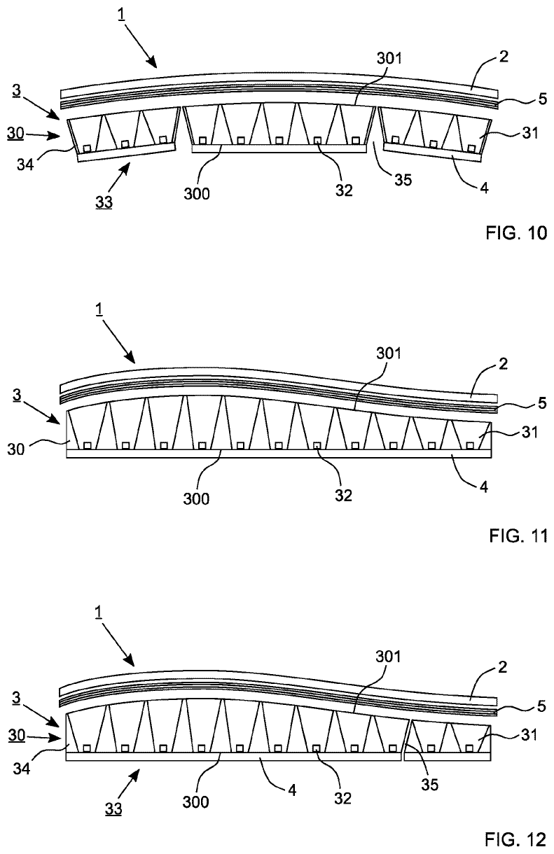

FIG. 10 schematically shows a display device 1 with a convex display panel 2. A section through the display device 1 is shown. The display device largely corresponds to the display device shown in FIG. 9. The reflector 30 is again of modular construction, but the various circuit boards 4 of the modules 33 lie in mutually inclined planes.

In FIG. 9 and FIG. 10, the reflector 30 has a modular construction. This is however not mandatory. The reflector 30 can also be designed in one piece. In this case, the underside 300 of the reflector 30 is flat in sections.

FIG. 11 schematically shows a display device 1 having a display panel 2 with a regionally convex and concave curvature. An underside 300 of the reflector 30 again has a flat design, whereas an upper side 301 of the reflector 30 is adapted to the curvature of the display panel 2.

FIG. 12 schematically shows a a display device 1 having a display panel 2 with a regionally convex and concave curvature. The reflector 30 has a modular design. In this case, the individual modules 33 each have a circuit board 4 with light sources 32 arranged thereon and a reflector element 34. In the example shown, a free space 35 for avoiding stresses and deformations in the event of an expansion of the modules 33 is situated between adjacent modules 33.

Of course, the aspects illustrated by the various embodiments can be combined with one another if required.

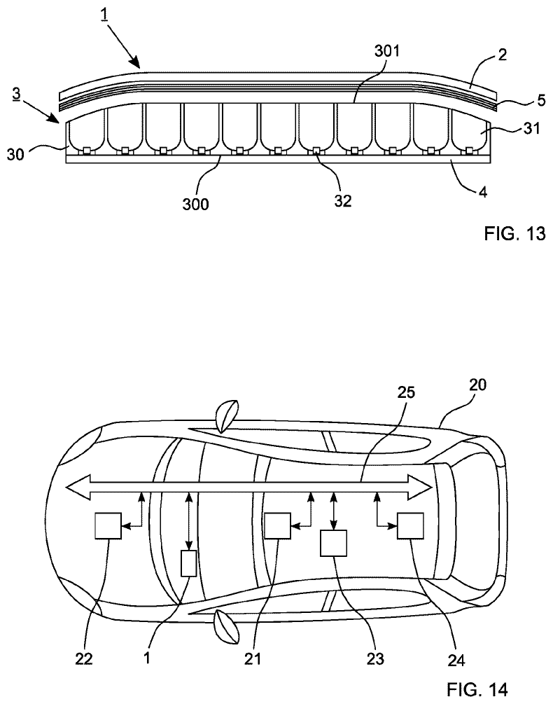

FIG. 13 schematically shows a display device 1 with a partially flat display panel 2. In this example, only the edge regions of the display panel 2 are convexly curved, while the central region of the display panel 2 has no curvature. An underside 300 of the reflector 30 again has a flat design, while an upper side 301 of the reflector 30 is adapted to the course of the curvature of the display panel 2.

FIG. 14 schematically shows a vehicle 20 that uses a display device 1. The vehicle 20 is in this example a motor vehicle. The motor vehicle has a display device 1, which is arranged in a dashboard. A sensor system 21 can be used to capture data pertaining to the vehicle surroundings. The sensor system 21 may in particular comprise surroundings recognition sensors, for example ultrasound sensors, laser scanners, radar sensors, lidar sensors or cameras. The information captured by the sensor system 21 can be used to generate contents to be displayed for the display device 1. Further component parts of the motor vehicle in this example are a navigation system 22, by which positional information can be provided, and also a data transmission unit 23. By means of the data transmission unit 23, it is possible e.g. to establish a connection to a back-end, for example in order to obtain updated software for components of the motor vehicle. A memory 24 is available for storing data. Data is exchanged between the various components of the motor vehicle via a network 25.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-9. (canceled)

10. A display device comprising:
a curved display panel; and
a backlight for the display panel, wherein the backlight has:
at least one flat circuit board with a plurality of light sources; and
a reflector with a plurality of reflective cavities in each of which at least one of the light sources is arranged,
wherein an underside of the reflector is flat, while an upper side of the reflector is adapted to a curvature of the display panel.

11. The display device according to claim 10, wherein the upper side of the reflector follows the curvature of the display panel or approximates the curvature of the display panel.

12. The display device according to claim 10, wherein the upper side of the reflector is designed to be convex, concave, regionally convex and concave or partially flat.

13. The display device according to claim 10, wherein a density of the light sources varies over a surface of the at least one flat circuit board.

14. The display device according to claim 10, wherein the light sources are controlled or designed such that a light intensity of the light sources varies over a surface of the at least one flat circuit board.

15. The display device according to claim 10, wherein the display device has a plurality of flat circuit boards in a spatial arrangement, each with a plurality of light sources.

16. The display device according to claim 10, wherein the reflector has a modular construction.

17. The display device according to claim 10, wherein walls of the cavities are parabolically or at least partially rounded and the cavities are designed to reflect the light emitted by the light sources in a direction of the display panel.

18. A transport comprising:
a display device comprising:
a curved display panel; and
a backlight for the display panel, wherein the backlight has:
at least one flat circuit board with a plurality of light sources; and
a reflector with a plurality of reflective cavities in each of which at least one of the light sources is arranged,
wherein an underside of the reflector is flat, while an upper side of the reflector is adapted to a curvature of the display panel.
